(19) United States
(12) Patent Application Publication
(10) Pub. No.: US 2004/0144618 A1
(43) Pub. Date: Jul. 29, 2004

(54) Orienting and feeding apparatus and method for manufacturing line

(76) Inventors: Walter McDonald, Newton, NJ (US); Norbert J. Seitel, Gillette, NJ (US)

Correspondence Address: KLAUBER & JACKSON, 411 HACKENSACK AVENUE, HACKENSACK, NJ, 07601

(21) Appl. No.: 10/353,638

(22) Filed: Jan. 29, 2003

(51) Int. Cl. B65G 47/24

(52) U.S. Cl. 198/389

(57) ABSTRACT

Apparatus and methods for rapidly orienting and feeding generally cylindrical, elongated objects having a maximum transverse diameter Y. First and second conveying belts are provided having input and output ends for cooperatively conveying such objects toward a downstream processing line. The belts are mounted so that their respective conveying surfaces are movable in a common parallel direction. The facing edges of the conveying surfaces of these belts are spaced from one another to define a uniform gap between them of a dimension less than Y. The conveying surfaces are upwardly sloped away from the gap, to define a zone converging downwardly in the direction of the gap. Object input means deposit the initially unoriented elongated objects at the input ends of the conveying belts. The belts are moved in a common direction, but at different speeds. The elongated objects are rotated by contact with the differentially speeding belts as they descend into the converging zone and become supported at the gap and conveyed by riding on the edges of the moving belts which border the gap. The objects as they descend become oriented in positions of gravitationally maximum stability relative to the mode of support, these positions being characteristic for the objects. Object output means at the ends of the belts receive the oriented objects and direct them toward the downstream processing line.

### BACKGROUND OF THE INVENTION

This invention relates generally to apparatus and methods which are useful in orienting and feeding large numbers of successive objects from a supply source to a downstream processing station. More specifically the invention relates to such apparatus and methods which are particularly applicable in the orienting and feeding of generally cylindrical, substantially identical elongated objects.

In the course of manufacturing or assembling various manufactured goods it is often desirable to orient and feed components or precursors of the goods from a supply source to a downstream processing station at which the components or precursors may be further processed or assembled with other components. Typical manufacturing operations to which the invention is applicable are blow molding operations and trimming operations. At one point e.g., in the manufacture of mass produced blow molded objects such as plastic containers for beverages or other liquids, so called “preforms” are fed from a container or hopper to a downstream station or stations where the actual blow molding operations will occur. In order to carry out this operation in a rapid and accurate fashion it is necessary to order these preforms into a single line of successive units, all of which are appropriately and identically oriented, and which are then directed in single file rapidly moving fashion to the further station(s) such as those of a blow molding operation. Basically therefore one starts with a collection of preforms in a large hopper or container and processes these through an orienting and feeding station as to end up with an output flow of single file preforms, all properly oriented for further processing at downstream stations.

An example of a well known blow molding preform to which the invention is applicable, is an elongated generally cylindrical plastic object, one end of which is a threaded neck for the ultimate blow molded container, and the other end of which extends from that threaded neck as a tubular portion which during the blow molding operation will be softened and enlarged into the ultimate container which terminates at the threaded neck.

In another example, relating to trimming, a somewhat dumbbell shaped elongated piece of plastic constitutes the elongated object. The enlarged ends of the “dumbbell” are substantially finished blow molded bottles, with the narrow connecting portion of the “dumbbell” joining the threaded necks for the two containers. This structure after proper orienting and feeding in accordance with the invention, will at a downstream point be cut into two bottles and a third connecting component by appropriately severing the connecting neck.

In the past it has proved very difficult to orient and feed elongated objects of the foregoing types in rapid fashion. Many prior art devices have relied upon complex rotating tables and the like having deflecting surfaces which orient the objects as they spin and centrifugally move on the table to which they are fed, so as to enable the objects to exit from a peripheral point of the table properly oriented. These devices are unfortunately not capable of rapid and accurate processing of the objects. Accordingly a need exists for apparatus which are capable of orienting and accurately and rapidly feeding such elongated objects in the manner of interest to the manufacturer.

### SUMMARY OF INVENTION

Now in accordance with the present invention we have devised apparatus and methods which are fully capable of rapidly orienting and feeding generally cylindrical, substantially identical elongated objects which are broadly characterized by having a maximum transverse diameter Y. In accordance with the invention first and second continuous conveying belts are provided having input and output ends for cooperatively conveying such objects toward a downstream processing line. The belts are mounted so that their respective conveying surfaces are movable in a common parallel direction. The facing edges of the conveying surfaces of these belts are spaced from one another to define a uniform gap between them of a dimension less than Y. The conveying surfaces reside and are movable in planes which are upwardly sloped away from the gap. The surfaces thereby define a zone converging downwardly in the direction of the gap. Object input means are provided for depositing the then unoriented elongated objects at the input ends of the conveying belts and object output means at the distal ends of the belts receive the objects, which are then oriented, and direct them toward the downstream processing line. In accordance with the orienting feature of the invention means are provided for moving the belts in a common direction, but at different respective speeds. In consequence the unoriented elongated objects deposited at the input ends of the belts are rotated by contact with the differentially speeding belts as the objects descend into the converging zone and become supported at the gap and conveyed by riding on the edges of the moving belts which border the gap. The objects as they descend become oriented in positions of gravitationally maximum stability relative to the mode of support, these positions being commonly characteristic for the particular objects.

The invention similarly constitutes a method for orienting and feeding generally cylindrical and identical elongated objects having a maximum transverse diameter Y. When considered as a method, first and second continuous conveying belts are provided having input and output ends for cooperatively conveying the objects toward a processing line. The belts are mounted so that the respective conveying surfaces are movable in a common parallel direction with the facing edges of the conveying surfaces of the belts being spaced from one another to define a uniform gap there between of a dimension less than Y. The conveying surfaces reside and are movable in respective planes which are upwardly sloped away from the gap, the surfaces thereby defining a zone converging downwardly in the direction of the gap. The unoriented objects are deposited at the input end of belts and during conveyance are oriented so that at the belt output ends the objects are received in oriented positions and directed toward the further processing line. In accordance with the invention the conveying belts are moved in a common direction but at different respective speeds, whereby the elongated unoriented objects deposited at the input ends are rotated by contact with the differentially speeding belts permitting the objects to descend in the converging zone and be supported at the gap while being conveyed by riding on the edges of the moving belts which border the gap. The objects as they descend are thus oriented in positions of gravitationally maximum stability relative to their said support, the positions being commonly characteristic for the objects being considered.

The said objects are typically fed to the input ends of the belts from a supply hopper or other container via a supply belt on which the objects are deposited as substantially a single layer of randomly oriented objects for feeding to the moving conveying belts as a collection of mutually spaced such objects. The conveying belts are preferably flattened closed loops, the conveying surfaces of which are defined at the uppermost sides of the loops. The conveying belts are preferably moved at a differential speed in the range of 110% to 180% (i.e., one belt moves at a speed which is 1.1. to 1.8 times faster than the other). The difference in speed is more generally such in relation to the path length for conveyance that the objects can be rotated as they descend in the converging zone to the desired new stable positions. The apparatus and method may include features for removing objects at the output ends of the conveying belts which have not properly descended in the converging zone to achieve the desired stable support positions at the gap. These mis-oriented objects are recycled to an upstream point for further treatment in accordance with the invention.

### BRIEF DESCRIPTION OF DRAWINGS

The invention is diagrammatically illustrated, by way of example, in the drawings appended hereto in which:

FIG. 1 is a perspective view of a first embodiment of orienting and feeding apparatus in accordance with the present invention;

FIG. 2 is an end view of the apparatus of FIG. 1, viewed from the input end of the object conveying belts; and

FIG. 3 is a perspective view of a second embodiment of apparatus for orienting and feeding elongated objects in accordance with the present invention.

### DESCRIPTION OF PREFERRED EMBODIMENT

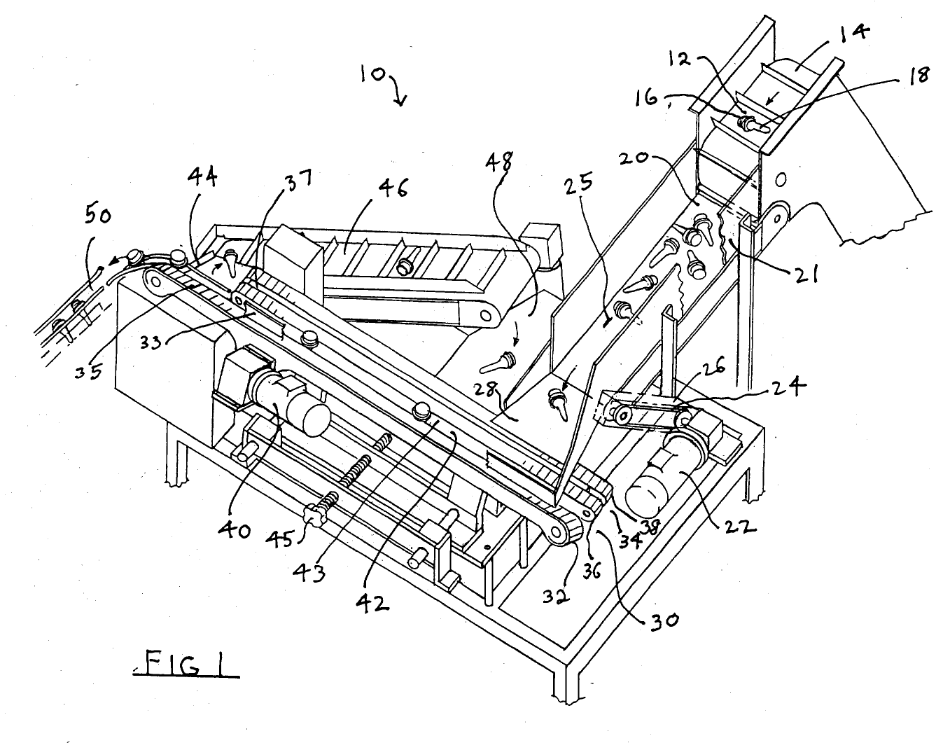

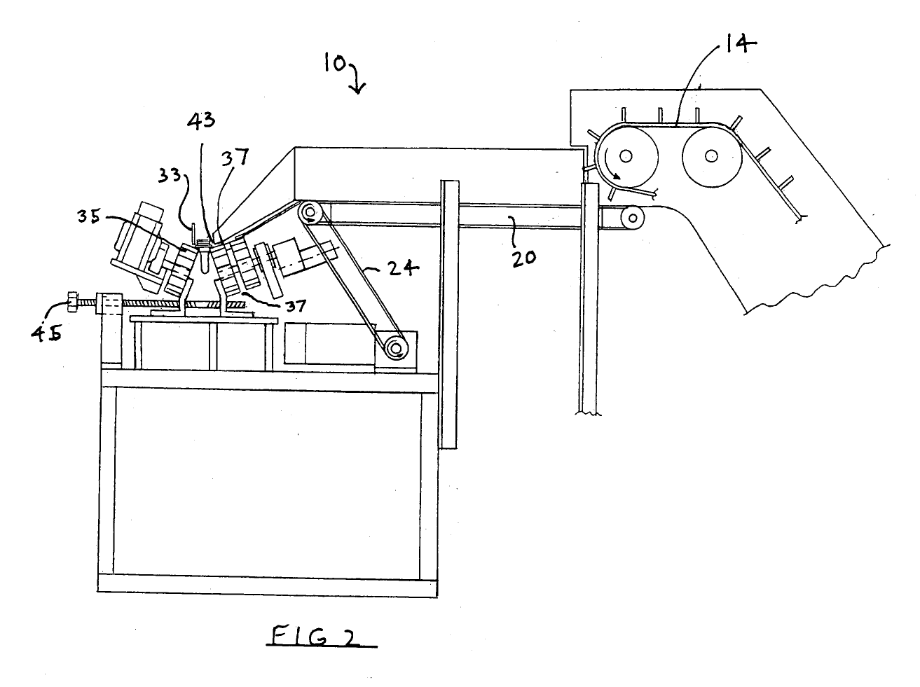

The apparatus 10 shown in FIGS. 1 and 2 is particularly useful for orienting and feeding preforms of a type that has been previously discussed. These preforms are intended for orienting and feeding to a downstream processing point where they will be subjected to a blow molding process in order to produce a container of the type commonly used for various liquids such as large plastic beverage containers and the like. These preforms 12 are fed from an input bin (not shown) via a supply input belt 14. The representative preform 12 is a moldable plastic product which is well known. It is a unitary structure having an enlarged threaded portion 16 from which extends a tubular portion 18 which is of reduced diameter and which is heavier than the portion 16. As has previously been discussed the threaded portion 16 will ultimately form the neck of the blow-molded container, whereas the tubular portion 18 will form the hollow body of the container. The preform 12 is seen to be generally cylindrical and its largest transverse diameter is defined at portion 16.

The preforms 12 are next deposited upon a feed input belt 20 which is operated by a motor 22 which actuates a timing belt 24 for belt 20. A guard 26 surrounds the timing belt. Preforms 12 are deposited upon the surface 25 of input belt 20 substantially as a single layer so that they become relatively spread out as separated objects as they proceed to the remainder of apparatus 10. One of the guide walls 21 bordering belt 20 has been partially broken away to better show this. As seen in FIGS. 1 and 2 the preforms 12 descend down a chute 28 whereupon they reach the feed orienting and conveying belts 30. In the embodiment shown in FIGS. 1 and 2 the conveying belts 30 comprise a first belt 32 and a second belt 34. The latter can comprise a single wide belt, but in this embodiment actually comprises two commonly driven sub-belts 36 and 38.

Belts 32 and 34 are driven by separate motors and gearing arrangements, one such motor and gear box being shown at 40. The speed of these motors is separately controlled with the objective that the belts 32 and 34 are driven at different speeds. The preferable differential speed is in the range of approximately 110 to 180 percent. The belt 34 as mentioned consists of two sub-belts 36 and 38 in order to give it a greater width. This is necessary since the objects being fed from chute 28 proceed from the outer side of belt 34, which preferably has a sufficient width at its upwardly facing conveying surface to accommodate the approximate length of the elongated objects even when crosswise, thereby preventing the objects from falling off. The opposed first belt 32 is provided with a guard edge 33 (shown in FIG. 2 and partially in FIG. 1) to prevent the preforms from inadvertently falling from that side of the moving belts 30.

A basic feature of the invention as seen in FIGS. 1 and 2 is that the belts 32 and 34 have their conveying surfaces 35 and 37 in planes which are sloped upwardly away from the space or gap 42 which is defined between the adjacent edges of the parallel moving belts. These sloping surfaces provided by the belts therefore define a converging zone 43 wherein the preforms 12 gravitationally descend toward the gap 42. The angle of convergence for this zone is generally in the range of 90° to 120°, but may vary depending upon the objects being oriented, and other factors such as the rates of belt advance. The preforms 12 are objects which are generally cylindrical and have a maximum diameter Y defined by the threaded neck portion 16. The gap 42 between the belts 32 and 34 is of a dimension which is less than Y but greater than the smallest transverse diameter of tubular portion 18 of preforms 12. Gap 42 can be varied by an adjusting screw 45. Because of the differential speed of movement of the conveying surfaces of the belts 32 and 34 the preforms 12 as they descend in converging zone 43 are rotated by contact with the belts on each side of the object, and as they drop toward and into gap 42 they achieve their characteristically gravitationally most stable position. In this case that position is one wherein the heavier tubular portion 18 slides downward into and through the gap 42 and wherein the enlarged neck portion 16 rides upon the adjacent edges of the two conveying surfaces 35 and 37. The preforms 12 are therefore now properly oriented and continue downstream.

A deflecting surface 44 is provided at the output ends of the belts 30 to deflect any preforms which are not properly oriented and seated in the gap 42, so that these deflected objects proceed to the right in the sense of FIG. 1 onto a recycle conveyer 46, which feeds these recycled objects back to the belts 30 at an upstream point via return chute 48.

From the output end of the apparatus 10 the now oriented preforms 12 proceed via an output chute or channel 50 where they are advanced to a further station as for example the aforementioned blow molding station (or associated stations) at which heating and blow molding of the preforms 12 may occur.

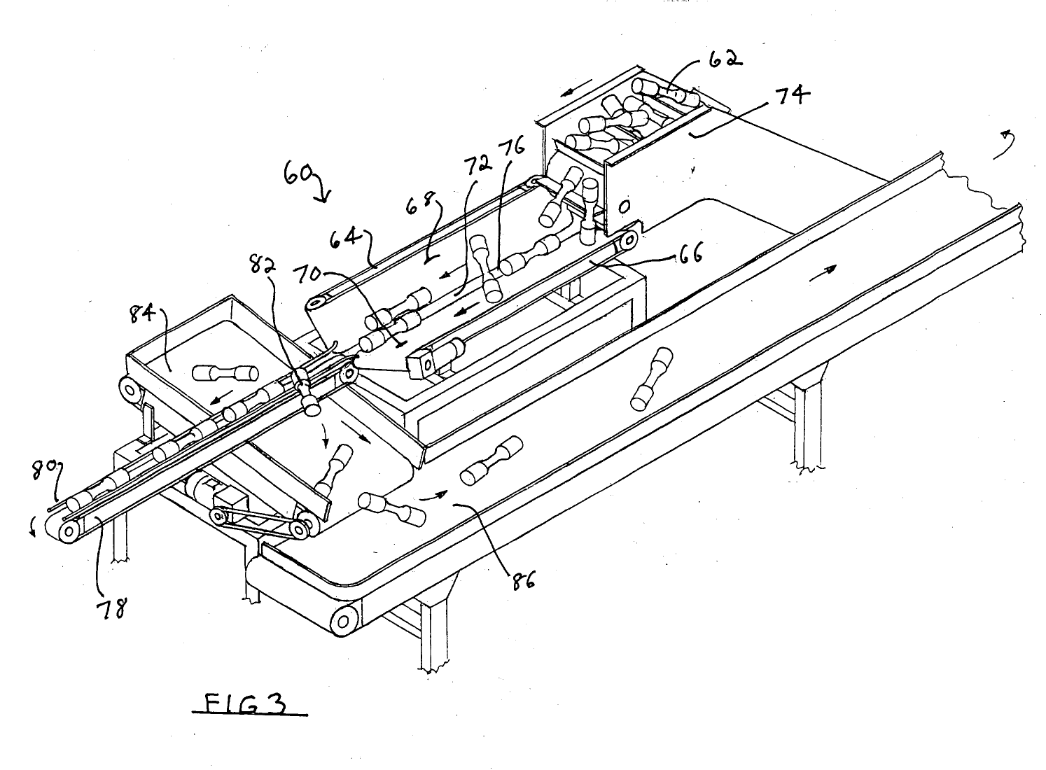

The further embodiment of the invention shown in FIG. 3 operates on principles which are substantially those in the apparatus of FIG. 1. However the apparatus 60 of FIG. 3 is particularly adapted for feeding of the “dumbbell”-shaped objects 62, which constitute two substantially formed bottles which are connected by a reduced center portion, as has been discussed in connection with the “Background” portion of this specification. In the embodiment of FIG. 3 the feed conveyer belts 64 and 66 similarly are oriented so that their conveying surfaces 68 and 70 slope upwardly away from the gap 72 present between the edges of the adjacent commonly moving belts. The objects 62 are fed and proceed from a bin or other supply source (not shown) via a supply input conveyer 74 which delivers objects 62 into the converging zone 76 defined between the upwardly sloping surfaces 68 and 70. The belts 64 and 66 are driven at different speeds as discussed in connection with the first embodiment of the invention. This rotates the objects 62 as they drop through the converging zone 76 so that they achieve a gravitationally stable position as they come to rest. The gap 72 has a dimension such as to be again less than the maximum transverse diameter of the objects 62, which maximum transverse diameter in this instance is present at each of the two ends. The gravitationally most stable position for these objects is thus one which is seen in FIG. 3, wherein the objects 62 become oriented lengthwise along and atop the gap and are carried thusly toward the output conveyer 78. Once they reach output conveyer 78 any objects which are not actually riding properly atop the gap 72 will fall to one or another side of output conveyer 78 because the height of the side rails 80 bordering same is only sufficient to restrain properly oriented objects which are seated directly on gap 72. The misoriented objects 82 will therefore drop off onto a recycle conveyer 84, then on to a return conveyer 86 which recycles the objects to the input bin (not show), and in due course to the supply input conveyer 74.

The belts 64 and 66 in the present embodiment are each a single relatively wide belt. The angle of convergence of between surfaces 68 and 70 is approximately 100°. More generally the angle of convergence will be in the range of 90° to 120° degrees. However, the specific angle of convergence can vary in the invention in accordance with the characteristics of the objects which are being fed and oriented. The two surfaces bounding the zone of convergence need not have an identical slope angle with respect to the gap.

While the present invention has been set forth in terms of specific embodiments thereof, it will be understood in view of the present disclosure that numerous variations upon the invention are now enabled to those skilled in the art, which variations yet reside within the present teachings. Accordingly, the invention is to be broadly construed and limited only by the scope and spirit of the claims now appended hereto.

1. Apparatus for orienting and feeding generally cylindrical identical elongated objects having a maximum transverse diameter Y; comprising:
first and second continuous conveying belts having input and output ends for cooperatively conveying said objects toward a processing line;
said belts being mounted so that the respective conveying surfaces are moveable in a common parallel direction; the facing edges of the conveying surfaces of said belts being spaced from one another to define a uniform gap therebetween, of a dimension less than Y;
said conveying surfaces residing and being movable in respective planes which are upwardly sloped away from said gap, said surfaces thereby defining a zone converging downwardly in the direction of said gap;
object input means for depositing said objects at said input ends of said belts;
object output means at said output end of said belts for receiving the objects and directing them toward said processing line; and
means for moving said belts in a common direction at different respective speeds, whereby randomly oriented elongated objects deposited at said input ends are rotated by contact with the differentially speeding belts, permitting the objects to descend in said converging zone and be supported at the gap and conveyed by riding on the edges of the moving belts which border the said gap, the objects so supported being oriented in positions of gravitationally maximum stability relative to their said support, said positions being commonly characteristic for the said objects.

2. Apparatus in accordance with claim 1, wherein said object input means includes an object conveyer belt, an object feed hopper, and means to move said objects from said hopper to said conveyer belts and deposit the objects thereon as substantially a single layer of randomly oriented objects for feeding to said moving belts as a collection of substantially mutually spaced objects.

3. Apparatus in accordance with claim 1, wherein said conveying belts are flattened closed loops, said conveying surfaces being defined at the uppermost sides of said loops.

4. Apparatus in accordance with claim 3 wherein said means for moving said belts at different speeds enable a differential speed in the range of 110 to 180%.

5. Apparatus in accordance with claim 1, further including means at the output ends of said conveying belts for removing objects which have not properly descended in said converging zone to said stable support positions at said gap and recycling said objects to an upstream point of said conveying belts.

6. Apparatus in accordance with claim 1, further including means for adjusting the size of said gap between said conveying belts.

7. Apparatus in accordance with claim 1, wherein the angle of convergence of said converging zone is in the range of 90° to 120°.

8. A method for orienting and feeding generally cylindrical identical elongated objects having a maximum transverse diameter Y; comprising:
providing first and second continuous conveying belts having input and output ends for cooperatively conveying said objects toward a processing line;
said belts being mounted so that the respective conveying surfaces are moveable in a common parallel direction; the facing edges of the conveying surfaces of said belts being spaced from one another to define a uniform gap therebetween, of a dimension less than Y;
said conveying surfaces residing and being movable in respective planes which are upwardly sloped away from said gap, said surfaces thereby defining a zone converging downwardly in the direction of said gap;
depositing said objects in randomly oriented fashion at said input ends of said belts;
moving said belts in a common direction at different respective speeds, whereby the elongated objects deposited at said input end are rotated by contact with the differentially speeding belts, permitting the objects to descend in said converging zone and be supported at the gap and conveyed by riding on the edges of the moving belts which border the said gap, the objects so supported being oriented in positions of gravitationally maximum stability relative to their said support, said positions being commonly characteristic for the said objects; and
receiving the oriented objects at said output end of said belts and directing them toward said processing line.

9. A method in accordance with claim 8, wherein said objects are fed to the input ends of said belts from a supply hopper via a supply conveyor belt on which the objects are deposited as substantially a single layer of objects for feeding to said moving conveying belts as a collection of substantially mutually spaced randomly oriented objects.

10. A method in accordance with claim 8, wherein said conveying belts are flattened closed loops, said conveying surfaces being defined at the uppermost sides of said loops.

11. A method in accordance with claim 10, wherein said conveying belts are moved at a differential speed in the range of 110 to 180%.

12. A method in accordance with claim 8, further including removing objects at the output ends of said conveying belts which have not properly descended in said converging zone to achieve said stable support positions at said gap, and recycling said objects to an upstream point of said conveying belts.

13. Apparatus for orienting and feeding elongated objects which have at one end a transversely enlarged generally cylindrical portion, with the remainder of said objects being a narrower and heavier tubular portion which extends from the enlarged portion; said apparatus comprising:
first and second continuous conveying belts having input and output ends for cooperatively conveying said objects toward a processing line;
means for moving said belts in a common direction;
said belts being mounted so that the respective conveying surfaces move in a common parallel direction; the facing edges of said belts being spaced from one another to define a uniform gap therebetween of a dimension greater than the transverse diameter of said tubular portion and less than the transverse diameter of said enlarged portion of said objects;
said conveying surfaces residing and moving in respective planes which are upwardly sloped away from said gap, said surfaces thereby defining a zone converging downwardly in the direction of said gap;
object input means for depositing said objects at said input end of said moving belts;
means for moving said belts at different respective speeds, whereby the elongated objects from said input end are rotated by contact with the differentially speeding belts, permitting the heavier tubular portion to descend in said converging zone and slip into said gap and point vertically downward while the object is supported at the gap and conveyed by the enlarged portion riding on the edges of the moving belts which border the said gap; and
object output means at said output end of said belts for receiving the oriented objects and directing them toward said processing line.

14. Apparatus in accordance with claim 13, wherein said object input means includes an object conveyer belt, a feed hopper, and means to move said objects from said hopper to said conveyer belt and deposit the objects thereon as substantially a single layer of objects for feeding to said moving belts as a collection of substantially mutually spaced objects.

15. Apparatus in accordance with claim 13, wherein said conveying belts are flattened closed loops, said conveying surfaces being defined at the uppermost sides of said loops.

16. Apparatus in accordance with claim 15, wherein said objects are preforms for blow molding, and said processing line is a blow molding line.

17. Apparatus in accordance with claim 15, wherein said means for moving said belts at different speeds enables a differential speed in the range of 110 to 180%.

18. A method for orienting and feeding elongated objects which have at one end an enlarged generally circular portion from which extends a narrower elongated and heavier tubular portion; comprising:
providing a pair of conveying surfaces the adjacent edges of which are parallel to one another and are spaced to define a uniform gap therebetween, the gap spacing being of a dimension greater than said tubular portion and less than the diameter of said enlarged portion of said objects;
said conveying surfaces residing in respective planes which are upwardly sloped away from said gap, said surfaces thereby defining a zone converging downwardly in the direction of said gap;
depositing said objects at said converging zone; and
moving said conveying surface in a common direction toward a feed point but at different respective speeds, whereby the elongated objects from said input end are rotated by contact with the differentially speeding conveying surfaces, permitting the heavier tubular portion to descend in said converging zone and slip into said gap and point vertically downward while the object is supported at the gap and conveyed by the enlarged portion riding on the edges of the moving belts which border the said gap.

19. A method in accordance with claim 18, wherein said conveying surfaces are present at conveying belts which are flattened closed loops, said conveying surfaces being defined at the uppermost sides of said loops.

20. A method in accordance with claim 19, wherein said objects are preforms for blow molding, and said feed point is a blow molding line.

21. A method in accordance with claim 18, wherein said conveying surfaces are moved at a differential speed in the range of 110 to 180%.

22. Apparatus for orienting and feeding generally cylindrical elongated objects having transverse diameters a and b at their opposite ends, toward a downstream processing line; comprising:
first and second continuous conveying belts having input and output ends for cooperatively conveying said objects toward a downstream processing line;
means for moving said conveying belts in common parallel directions;
said belts being mounted so that facing edges of the respective conveying surfaces are spaced from one another to define a uniform gap between the belts, the gap spacing being of a dimension less than the transverse diameters a and b of said objects;
said conveying surfaces residing and being moveable in respective planes which are upwardly sloped away from said gap, said surfaces thereby defining a zone converging downwardly in the direction of said gap;
object input means for depositing said objects at said input ends of said moving belts;
object output means at said output end of said belts for receiving the objects and directing them toward said processing line; and
means for moving said belts at different respective speeds, whereby the elongated objects from said input end are rotated by contact with the differentially speeding belts as they descend in said converging zone and attain gravitationally stable positions at said gap where the objects are supported at the gap with their elongated dimension parallel to the direction of belt movement and are conveyed by riding on the edges of the moving belts which border the said gap.

23. Apparatus in accordance with claim 22, wherein said conveying belts are flattened closed loops, said conveying surfaces being defined at the uppermost sides of said loops.

24. Apparatus in accordance with claim 23, wherein said objects are preforms for blow molding, and said processing line is a blow molding line.

25. Apparatus in accordance with claim 23, wherein said means for moving said belts at different speeds enables a differential speed in the range of 110 to 180%.

26. A method for orienting and feeding generally cylindrical elongated objects having transverse diameters a and b at their opposed ends, toward a downstream processing line; comprising:
providing a pair of conveying surfaces which are movable in a common direction, the adjacent edges of said surfaces being parallel to one another and spaced to define a uniform gap therebetween, the gap spacing being of a dimension less than said diameter a and b of said objects;
said conveying surfaces being movable toward an object feed point, and residing and movable in respective planes which are upwardly sloped away from said gap, said surfaces thereby defining a zone converging downwardly in the direction of said gap;
depositing said objects at said converging zone; and
moving said conveying surfaces in a common direction toward said feed point but at different respective speeds, whereby the elongated objects from said input end are rotated by contact with the differentially speeding conveying surfaces, permitting the objects to descend in said converging zone and attain commonly oriented gravitational stable positions at said gap with them long axis parallel to the direction of belt movement the object being supported at the gap and conveyed by riding on the edges of the moving belts which border the said gap.

27. A method in accordance with claim 26, wherein said conveying surfaces are present at conveying belts which are flattened closed loops, said conveying surfaces being defined at the uppermost sides of said loops.

28. A method in accordance with claim 27, wherein said objects are preforms for blow molding, and said feed point is a blow molding line.

29. A method in accordance with claim 26, wherein said conveying surfaces are moved at a differential speed in the range of 110 to 180%.

30. A method in accordance with claim 26 wherein the angle of convergence of said converging zone is in the range of 90° to 120°.
